(19) United States
(12) Patent Application Publication
(10) Pub. No.: US 2017/0147586 A1
(43) Pub. Date: May 25, 2017

(54) METHOD AND ELECTRONIC DEVICE FOR SEARCHING VIDEO CONTENTS

(71) Applicants: Le Holdings (Beijing) Co., Ltd., Beijing (CN); LE SHI INTERNET INFORMATION & TECHNOLOGY CORP., BEIJING, Beijing (CN)

(72) Inventors: Yu ZHAO, Beijing (CN); Shibin LI, Beijing (CN); Jianwei GUO, Beijing (CN); Xiaolei NIU, Beijing (CN); Ruotao WANG, Beijing (CN)

(73) Assignees: Le Holdings (Beijing) Co., Ltd., Beijing (CN); LE SHI INTERNET INFORMATION & TECHNOLOGY CORP., BEIJING, Beijing (CN)

(21) Appl. No.: 15/240,412

(22) Filed: Aug. 18, 2016

Related U.S. Application Data
(63) Continuation of application No. PCT/CN2016/083747, filed on May 27, 2016.

(30) Foreign Application Priority Data
Nov. 25, 2015 (CN) 201510834091.3

(51) Int. Cl. G06F 17/30; H04N 21/84; H04N 21/482

(52) U.S. Cl. CPC G06F 17/3082; G06F 17/30784; G06F 17/30823; H04N 21/4828; H04N 21/84

(57) ABSTRACT

Embodiments of the present application provide a method, apparatus and electronic device for searching video contents. Said method comprises: obtaining a plot search keyword for a target video; obtaining, from pre-stored additional information of the target video, a first playback time information of a first video plot information matching the plot search keyword, wherein the additional information of the target video is for recording video plots information of the target video and playback time information corresponding to the video plots information. According to the embodiments of the present application, the user can accurately find corresponding video contents in the target video, thereby improving the user's video viewing experience.

This application is based upon and claims priority to Chinese Patent Application No. 201510834091.3, titled “Method, Apparatus and Electronic Device for Searching Video Contents”, filed on Nov. 25, 2015, the entire contents of which are incorporated herein by reference.

### TECHNICAL FIELD

The present disclosure relates to computer technology, more specifically, to a method, apparatus and electronic device for searching video contents.

### BACKGROUND

With the advance of computer technology and internet technology, construction of the information highway and broad usage of multimedia, a variety of video resources are being continuously produced. As a result, an increased number of video databases are established. Obtaining desired video resources from the massive video resources and further quickly obtaining contents in a particular video relevant to specific plot become technical problems to be solved. At present, when searching video, a user inputs a term/terms related to the video content to be searched, the name of the video that matches the search term is then obtained from a video database. The obtained video content is presented to the user.

However, it is impossible to obtain a plot (segment or playback start time) of a certain video content matching the search term(s) input by the user with the above searching method. That makes it difficult to accurately obtain corresponding video contents, and the user's video viewing experience is reduced.

### SUMMARY

The goal of the present disclosure is to provide a technical solution of accurately obtaining video contents relevant to a certain video plot from a target video, an apparatus and an electronic device for implementing such technical solution, in which video contents relevant to a corresponding video plot through search keyword(s) of the plot are obtained, so that the user can accurately obtain a corresponding video content in a target video, improving the user's video viewing experience.

According to an aspect of the present application, a method for searching video contents is provided, said method including: obtaining a plot search keyword for a target video; obtaining, from pre-stored additional information of the target video, a first playback time information of a first video plot information matching the plot search keyword, wherein the additional information of the target video is for recording video plots information of the target video and playback time information corresponding to the video plots information.

According to another aspect of the present application, an apparatus for searching video contents is provided, the apparatus including: a keyword obtaining module, configured to obtain a plot search keyword for a target video; a time obtaining module, configured to obtain, from pre-stored additional information of the target video, a first playback time information of a first video plot information matching the plot search keyword obtained by the keyword obtaining module, wherein the additional information of the target video is for recording video plots information of the target video and playback time information corresponding to the video plots information.

According to yet another aspect of the present application, an electronic device is provided, including: a memory, configured to store a program; one or more processor(s), configured to execute the program stored in the memory, said program causing the one or more processor(s) to execute instructions for the above method for searching video contents.

According to yet another aspect of the present application, a computer program is provided, said computer program including a computer readable code, which when executed on an electronic device, causes the electronic device to execute instructions for the above method for searching video contents.

According to yet another aspect of the present application, a computer readable medium is provided, on which the above computer program is stored.

In the method, apparatus, electronic device for searching video contents provided in the embodiment of the present application, a plot search keyword is obtained and a first playback time information of a first video plot information matching a plot search keyword is obtained from pre-stored additional information of a target video, so that the user can accurately find corresponding video contents in the target video, thereby improving the user's video viewing experience.

It is to be noted that the general descriptions above and the detailed descriptions that follow are merely exemplary and descriptive, and cannot limit the present application.

### BRIEF DESCRIPTION OF THE DRAWINGS

For clarity of descriptions on the embodiments of the present application, accompanying drawings used in descriptions on the embodiments are briefly introduced below. It is apparent that the accompanying drawings described below merely cover certain embodiments of the present application and that those skilled in the art can obtain, without exerting creative efforts, other drawings from these accompanying drawings.

FIG. 1 is a flow chart illustrating a method of searching video contents according to a first embodiment of the present disclosure.

FIG. 2 is a flow chart illustrating a method of searching video contents according to a second embodiment of the present disclosure.

FIG. 3 is a flow chart illustrating a method of searching video contents according to a third embodiment of the present disclosure.

FIG. 4 is a logic diagram illustrating an apparatus for searching video contents according to a fourth embodiment of the present disclosure.

FIG. 5 is another logic diagram illustrating another apparatus for searching video contents according to a fourth embodiment of the present disclosure.

FIG. 6 is yet another logic diagram illustrating yet another apparatus for searching video contents according to a fourth embodiment of the present disclosure.

FIG. 7 is yet another logic diagram illustrating yet another apparatus for searching video contents according to a fourth embodiment of the present disclosure.

FIG. 8 is a structural diagram illustrating an electronic device to a fifth embodiment of the present disclosure.

Particular embodiments of the present application have been shown with reference to the above accompanying drawings, and more detailed descriptions will be given hereinafter. These accompanying drawings and literal descriptions are not intended to limit the scope of the inventive concepts by any means, but rather the inventive concepts are explained with reference to the particular embodiments for those skilled in the art.

### DESCRIPTION OF THE EMBODIMENTS

The inventive concept of the present application is to provide a method, an apparatus and an electronic device for accurately obtaining video contents related to certain video plot, with which plot related information is searched with a search keyword about a plot and information about a corresponding playback time is determined from the plot related information, so that the user can found corresponding video contents in a target video with accuracy, improving the user's video viewing experience.

Hereinafter, exemplary embodiments of the present application are described in details with reference to the accompanying drawings.

### Embodiment 1

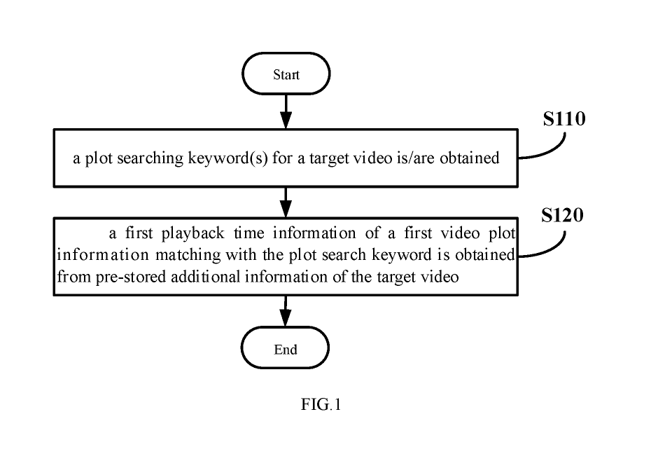

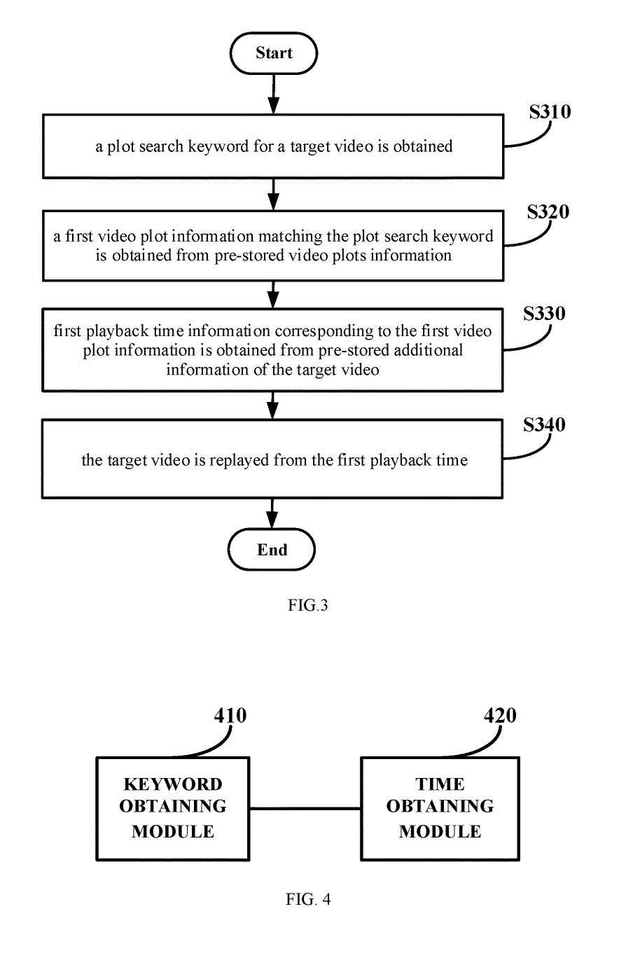

FIG. 1 is a flow chart illustrating a method for searching video contents according to a first embodiment of the present disclosure. The method is performed by the computer system containing the apparatus shown in FIG. 4, wherein the apparatus for performing said method can be a terminal device (such as a mobile phone, a tablet, a notebook computer or a smart TV, etc.) or a server.

Referring to FIG. 1, in step S110, a plot searching keyword(s) for a target video is/are obtained.

Here, the target video may be any video content, for example, the video content of a certain episode of a television series or a movie, etc. The plot searching keyword can be any character, including but not limited to, words, symbols and/or digits, etc.

In particular, an application program for viewing video can be installed in a user terminal device (such as a mobile phone, a tablet, a notebook computer or a smart TV, etc.), with which the user can view corresponding video contents. When the user views a certain video (i.e. target video), the video playing interface for the application program may include a search box and a search button. If the user wants to view contents of a certain plot in the target video, he/she may input in the search box a corresponding plot search keyword and then click the search button, then the terminal device can obtain plot search keyword the user has input.

It should be noted, if processing of the above step S110 is performed by a server, then the terminal device may also send the plot search keyword the user has input to the server, so that the server may receive the plot search keyword of the target video.

In step S120, a first playback time information of a first video plot information matching with the plot search keyword is obtained from pre-stored additional information of the target video.

Here, the first video plot may be a video plot containing the plot search keyword, or maybe a video plot related to the plot search keyword. The additional information of the target video may be used to record the video plots information in the target video and playback time information corresponding to video plots information.

In particular, after the plot search keyword the user has input is obtained, said plot search keyword may be compared with the pre-stored video plots information of the target video. If the video plots information of the target video contains the video plot information related to the plot search keyword or contains the video plot information including the plot search keyword, said video plot information is determined as the first video plot information, and then a playback time information corresponding to the first video plot information (i.e. the first playback time) is obtained from the pre-stored video plots information of the target video. Or alternatively, a playing position in the target video may be determined for the first video plot and the corresponding playback time (i.e. the first playback time) is further determined. Here, there may be a plurality of the first video plots information determined from the plot search keyword. In this case, information of the plurality of the first video plots may be presented to the user to prompt the user to select the information of one of the first video plots. After the user completes the selection, the first playback time information may be determined for the information of the user selected first video plot.

It is to be noted, in the case of a plurality of the first video plots, apart from the above processing, other processing can also be performed. For example, video plots with the highest matching score with the plot search keyword can be selected from the plurality of the first video plots, or a video plot can be randomly selected from the plurality of the first video plots. The embodiments of the present application do not limit the processing on selecting one or more video plots from the plurality of the first video plots.

In the method for searching video contents provided in the embodiment of the present application, a plot search keyword is obtained and a first playback time information of a first video plot information matching a plot search keyword is obtained from pre-stored additional information of a target video, so that the user can accurately find corresponding video contents in the target video, thereby improving the user's video viewing experience.

### Embodiment 2

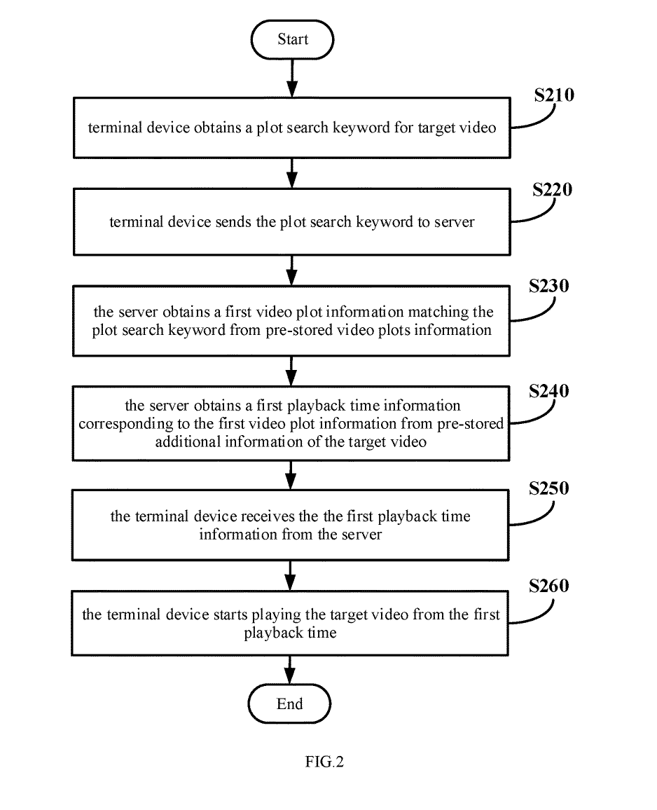

FIG. 2 is a flow chart illustrating a method of searching video contents according to a second embodiment of the present disclosure, which may be seen as a particular implementing scheme of the embodiment shown in FIG. 1. In the present embodiment, he method of searching video contents is mostly performed in a server, and accordingly the method is jointly completed by the server and the terminal device. The descriptions below can be referred to for its particular processing.

Typically various videos are stored in a video web site. For any given video, its contents are divided into multiple video plots, and corresponding plot literal information can be set for the video plots for describing the video plots of corresponding parts of contents. Also, the playback time corresponding to a video plot may be located in the video according to the plot literal information of each video plot, and information of a video plot and its playback time can be correspondingly stored. For the convenience of management of the video website, additional information can be set for each video, and the information on video plots of the video and their corresponding playback time can be stored in the video's additional information. An example of stored additional information is given in table 1.

TABLE 1
VIDEO A

| Video plots information | Playback time information |
|---|---|
| Plot Info 1 | 00:15:30 |
| Plot Info 2 | 00:25:00 |
| Plot Info 3 | 00:40:20 |

In addition, the administrator of the video website or a user can set and/or add video plots information and corresponding playback time information for a certain video, that is, creating additional information for the video according to actual needs, which additional information can be used to record the video plots information in a certain video and the playback time information corresponding to the video plots information. Corresponding processing can be referred to in the following step I through step IV.

In step I, the terminal device obtains a second video plot information in a target video and a second playback time information.

Therein, the second video plot information can be information related to a video plot in the target video, which is input by the user.

In particular, the user can add in the additional information of the target video, a new video plot information and the corresponding playback time information, and can make modification to the contents of the additional information. When the user needs to add corresponding information in the additional information of the target video, the corresponding application program or a corresponding instruction installed in the terminal device can provide the user with an information input box, in which the user may enter a second video plot information in the target video and a second playback time information. Upon completion of his/her input, he/she click a button for assertion. The terminal device then obtains the second video plot information and the second playback time information, input by the user.

In step II, the terminal device sends the second video plot information and the second playback time information to the server.

In particular, a video identifier (e.g. video name and/or video code, etc.) may be pre-assigned to each video to distinguish various videos. After the terminal device obtains the second video plot information and the second playback time information, it sends the second video plot information and the second playback time information along with the video identifier of the target video to the server. The server then will receive the second video plot information and the second playback time information along with the video identifier of the target video.

In step III, the server stores the second video plot information and the second playback time information in association with the additional information of the target video.

In particular, the server can obtain the target video according to the video identifier, and determine whether there already exists the second video plot information and the second playback time information in the additional information of the target video. If there already exists said information, then the server may determine information of the corresponding video plot has been set in the additional information, and may substitute the existing second video plot information and the second playback time information for the received second video plot information and the second playback time information in the additional information. If there does not exist said information, the server stores the second video plot information and the second playback time information in association with the additional information of the target video. Also, the server may label a position on a progression bar of the target video corresponding to the second playback time according to the received second video plot information and the second playback time information.

In step IV, the terminal device receives from the server a message for notifying the second video plot information and the second playback time information being stored in association with the additional information.

In particular, if the server has successfully stored the above information in the additional information of the target video, it may send a notification message indicating successful storage. If an error occurs when the server stores the above information, it may send a notification message indicating storage failure. At this point, the user may be prompted to re-store the above information until the above information is successfully stored or storage is abandoned. The above steps I˜IV may be repeated or executed cyclically, so that the additional information of the target video is obtained.

By means of the server storing additional information set for a video, the user may obtain contents related to a video plot in the video with a plot search keyword. The corresponding processing is described in step S210˜S260 below.

Referring to FIG. 2, in step S210, the terminal device obtains a plot search keyword for a target video.

Corresponding contents described in step S110 in the above embodiment I may be referred to for processing of step S210 and are not repeatedly described herein.

In step S220, the terminal device sends the plot search keyword to the server.

In particular, before the terminal device sends the plot search keyword to the server, it may obtain the video identifier of the video (target video) that is currently being played or being shown in a display interface. After the terminal device obtains a plot search keyword, it sends the plot search keyword and the obtained video identifier to the server.

In step S230, the server obtains a first video plot information matching the plot search keyword from pre-stored video plots information.

Corresponding contents described in step S120 in the above embodiment I may be referred to for processing of step S230 and are not repeatedly described herein.

In step S240, the server obtains a first playback time information corresponding to the first video plot information from pre-stored additional information of the target video.

In particular, after the server obtains the information of the first video plot, it can search in the additional information of the target video as shown in table 1 and obtains the first playback time information corresponding to the first video plot information. For example, referring to table 1, assuming that the target video is video A and that the information of the first video plot is plot information 1, it can be seen from the additional information in table 1 that the playback time information corresponding to plot information 1 is 00:15:30, which is the first playback time information.

In step S250, the terminal device receives the first playback time information from the server.

In step S260, the terminal device starts playing the target video from the first playback time.

In addition, apart from duly replaying the target video from the first playback time, the terminal device can also implement the corresponding process which queries the user whether to jump to the first playback time to replay the target video, and includes the following: outputting a prompt message for prompting the user whether to jump to the first playback time to replay the target video; in response to a jump command input by the user, replaying the target video from the first playback time.

In particular, for the purpose of not affecting the user's current viewing of the target video and improving the user's video viewing experience, when the terminal device receives the information on the first playback time, a popup box may be shown, which may include a prompt message for prompting the user whether to jump to the first playback time to replay the target video, a confirm button and/or a cancel button, etc. The user may decide whether to jump to the first playback time. If the user intends to jump, then the confirm button can be clicked. The terminal device then receives a jump command generated after the user clicks the confirm button, jumps to the first playback time from the current playback time and continues to play the target video.

It is to be noted, in the case that the server adds the second video plot information and the corresponding second playback time of the target video, the server can send the second playback time information to the terminal device, which can then mark the second playback time on the playback progression bar for the target video.

In the method for searching video contents provided in the embodiment of the present application, on the one hand, the server obtains a plot search keyword, obtains information of a first video plot matching the plot search keyword from pre-stored information on video plots, and then obtains a first playback time information corresponding to the first video plot information from the additional information of the target video, so that the user can accurately find corresponding video contents in the target video, thereby improving the user's video viewing experience. On the other hand, the terminal device can jump to the first playback time to replay the target video, thereby further improving the user's video viewing experience.

### Embodiment III

FIG. 3 is a flow chart illustrating a method of searching video contents according to a third embodiment of the present disclosure, which can be seen as another particular implementing scheme of the embodiment shown in FIG. 1.

In the present embodiment, whenever a user opens a video website through an application program, and clicks to view a certain video therein, the server sends the video data and its additional information to the terminal device, which can then temporarily store it in its local storage. When the user terminates the video, the terminal device may delete the video and its additional information from its local storage. Here, the additional information is for recording the video plots information of the video and playback time information corresponding to the video plots information. Corresponding contents described in the above embodiment II may be referred to for processing related to the additional information, and are not repeatedly described herein.

Referring to FIG. 3, in step S310, a plot search keyword for a target video is obtained.

In step S320, a first video plot information matching the plot search keyword is obtained from pre-stored video plots information.

In step S330, first playback time information corresponding to the first video plot information is obtained from pre-stored additional information of the target video.

In step S340, the target video is replayed from the first playback time.

Corresponding contents described in the above embodiment I and embodiment II may be referred to for processing in the above steps S310˜S340, and are not repeatedly described herein.

It is to be noted, if the user needs to add a new video plot information and its corresponding playback time information, or needs to modify corresponding information in the additional information, he/she may add corresponding information or modify corresponding information in the additional information in the local storage, and also update the additional information of the target video stored in the server. Corresponding contents described in steps I˜IV in the above embodiments II may be referred to for processing related to the additional information, and are not repeatedly described herein.

In the method for searching video contents provided in the embodiment of the present application, on the one hand, the terminal device obtains a plot search keyword, obtains a first video plot information matching the plot search keyword from pre-stored video plots information, and then obtains a first playback time information corresponding to the first video plot information from the additional information of the target video, so that the user can accurately find corresponding video contents in the target video, thereby improving the user's video viewing experience. On the other hand, the terminal device can jump to the first playback time to replay the target video, thereby further improving the user's video viewing experience.

### Embodiment IV

Based on the same technical concept, FIG. 4 is a logic diagram illustrating an apparatus for searching video contents according to a fourth embodiment of the present disclosure. Referring to FIG. 4, the apparatus includes a keyword obtaining module 410 and a time obtaining module 420, wherein the keyword obtaining module 410 is connected with the time obtaining module 420.

The keyword obtaining module 410 is configured to obtain a plot search keyword for a target video.

The time obtaining module 420 is configured to obtain a first playback time information on a first video plot matching the plot search keyword obtained by the keyword obtaining module 410 from pre-stored additional information of the target video. Wherein, the additional information of the target video is for recording video plots information in the target video and playback time information corresponding to the video plots information.

In the apparatus for searching video contents provided in the embodiment of the present application, a plot search keyword is obtained and a first playback time information of a first video plot information matching a plot search keyword is obtained from pre-stored additional information of a target video, so that the user can accurately find corresponding video contents in the target video, thereby improving the user's video viewing experience.

Further, on the basis of the embodiment as shown in FIG. 4, the time obtaining module 420 as shown in FIG. 5 includes: a plot information obtaining unit 421, configured to obtain a first video plot information matching the plot search keyword obtained by the keyword obtaining module 410 from pre-stored video plots information; time obtaining unit 422, configured to obtain the first playback time information corresponding to the information of the first video plot obtained by the plot information obtaining unit 421.

In addition, the time obtaining module 420 is configured to send the plot search keyword obtained by the keyword obtaining module 410 to the server, and to receive the first playback time information from the server.

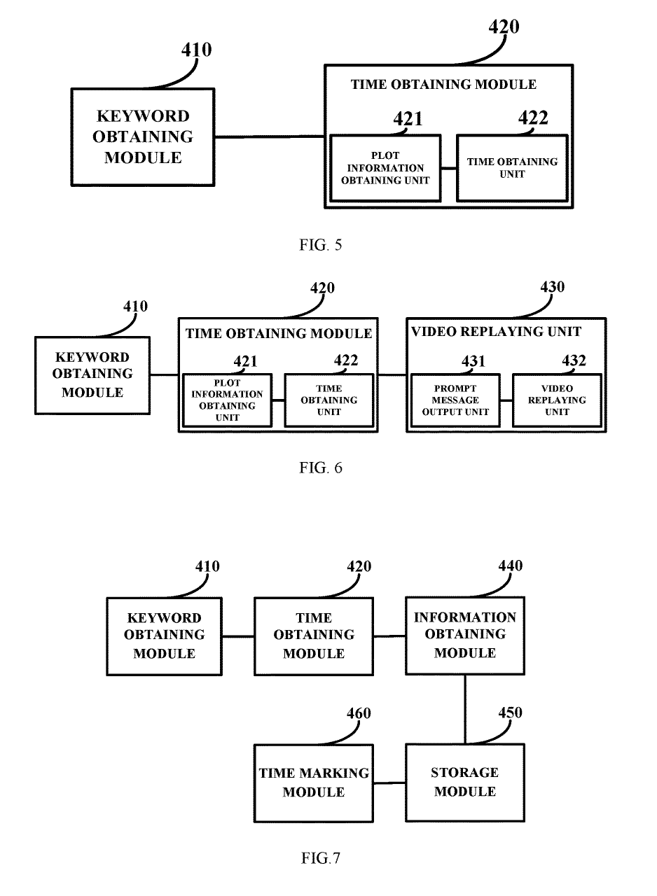

Further, on the basis of the embodiment as shown in FIG. 5, the apparatus as shown in FIG. 6 further includes: a video replaying module 430, configured to replay the target video from the first playback time obtained by the time obtaining module 420.

Also, the video replaying module 430 as shown in FIG. 6 includes: a prompt message output unit 431, configured to output a prompt message to query the user whether to jump to the first playback time obtained by the time obtaining module 420 to replay the target video; a video replaying unit 432, configured to replay the target video from the first playback time obtained by the time obtaining module 420, in response to a jump confirming command input by the user.

Further, on the basis of the embodiment as shown in FIG. 4, the apparatus as shown in FIG. 7 further includes: an information obtaining module 440, configured to obtain a second video plot information of the target video and a second playback time information; a storage module 450, configured to store the second video plot information and the second playback time information obtained by the information obtaining module 440 in association with the additional information of the target video.

Also, the storage module 450 is configured to send the second video plot information and the second playback time information obtained by the information obtaining module 440 to the server, and to receive from the server a message for notifying the second video plot information and the second playback time information being stored in association with the additional information of the target video.

Further, the apparatus as shown in FIG. 7 further includes: a time marking module 460, configured to mark the second playback time on the playback progression bar for the target video.

In the apparatus for searching video contents provided in the embodiment of the present application, on the one hand, a plot search keyword is obtained, a first video plot information matching the plot search keyword is obtained from pre-stored information on video plots, and then first playback time information corresponding to the first video plot information is obtained from the additional information of the target video, so that the user can accurately find corresponding video contents in the target video, thereby improving the user's video viewing experience. On the other hand, the target video can be replayed from the first playback time, thereby further improving the user's video viewing experience.

### Embodiment V

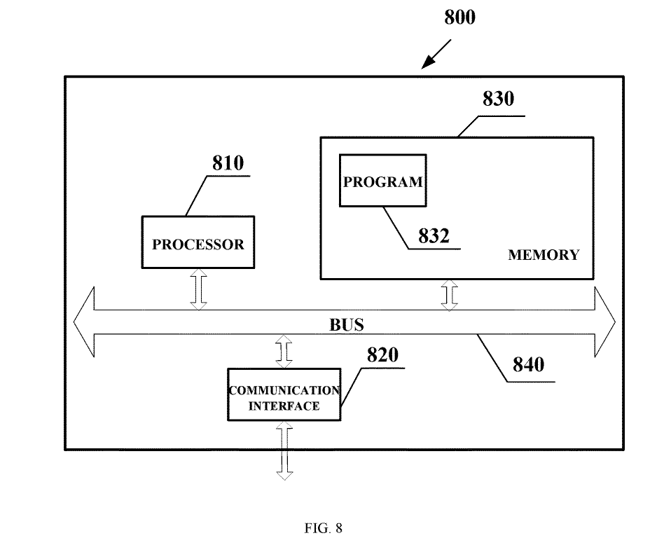

FIG. 8 is a structural diagram illustrating an electronic device to a fifth embodiment of the present disclosure. Particular embodiments of the present application do not limit the specific embodying form of the electronic device. Referring to FIG. 8, the electronic device 800 may include: a processor 810, a communication interface 820, a memory 830 and a communication bus 840. Wherein,

The processor 810, the communication interface 820 and the memory 830 perform communication with one another through the communication bus 840.

The communication interface 820 is adapted to communicate with other network units.

The processor 810 is adapted to execute a program 832, for performing corresponding steps described in the above embodiments for the method in particular.

Specifically, the program 832 can include program code, which includes computer executable instructions.

The processor 810 may be a central processing unit (CPU), or an Application Specific Integrated Circuit (ASIC), or one or more integrated circuits configured implementing the embodiments of the present application.

The memory 830 is adapted to store the program 832. The memory 830 may contain a high speed RAM (randomly accessed memory) memory or may contain a non-volatile memory, such as at least one disk memory. The program 832 is specifically configured to enable the electronic device 800 to perform the operations below: obtaining a plot search keyword for a target video; obtaining, from pre-stored additional information of the target video, a first playback time information of a first video plot information matching the plot search keyword, wherein the additional information of the target video is for recording video plots information of the target video and playback time information corresponding to the information of the video plots.

In a particular embodying mode, the program 832 may also be configured to enable the electronic device to perform the operations below: obtaining, from pre-stored video plots information, the first video plot information matching the plot search keyword; obtaining, from the additional information of the target video, the first playback time information corresponding to the first video plot information.

In a particular embodying mode, the program 832 may also be configured to enable the electronic device to perform the operations below: sending the plot search keyword to the server, and receiving the first playback time information from the server.

In a particular embodying mode, the program 832 may also be configured to enable the electronic device to perform the operations below: obtaining a second video plot information of the target video and a second playback time information; storing the second video plot information and the second playback time information in association with the additional information of the target video.

In a particular embodying mode, the program 832 may also be configured to enable the electronic device to perform the operations below: sending the second video plot information and the second playback time information to a server, and receiving from the server a message for notifying the second video plot information and the second playback time information being stored in association with the additional information of the target video.

Descriptions on corresponding steps and units in the above embodiments may be referred to for particular implementations of the operations performed in the program 832, and are not repeatedly described herein. Those skilled in the art can clear appreciate that for convenience and conciseness, the particular processing in the embodiment for the method can be referred to for the corresponding processing of the apparatus and modules described above, and is not repeatedly described herein.

In addition, the embodiments of the present application also provide a computer program, which includes computer executable code. When the computer executable code is executed on the electronic device, the electronic device is caused to perform the method for searching video contents described in any one of the embodiments of the multiple methods described above.

Also, the embodiments of the present application also provide a computer readable medium, on which the above computer program is stored.

Through the technical solutions provided in the embodiments of the present application, a plot search keyword is obtained and a first playback time information of a first video plot information matching a plot search keyword is obtained from pre-stored additional information of a target video, so that the user can accurately find corresponding video contents in the target video, thereby improving the user's video viewing experience.

It is to be noted, various steps/components described in the present application may be divided into more steps/components, two or more steps/components can be combined into new steps/components, or parts of steps/components can be combined into new steps/components, to achieve the goal of the present application.

In addition, typically, the electronic device described in the present application can be a variety of portable terminal device, such as a mobile phone, a personal digital assistant, a tablet PC, a smart TV, etc. Therefore, the scope of the present application should not be construed to limit to certain particular types of devices.

Also, the method addressed in the present application can also be implemented by a computer program executed by a CPU, which can be stored in a computer readable medium. When the computer program is executed by its CPU, the functions defined above in the method of the present application are performed.

Also, steps in the above method and system units may be implemented by a controller and a computer readable medium for storing a computer program causing the controller to execute the above steps or unit functions.

Also, it is to be understood, the computer readable medium mentioned herein (e.g. memory) can be a volatile memory or a non-volatile memory, or can include both. As an example, but not limited to, the non-volatile memory can include a read-only memory (ROM), a programmable ROM (PROM), an electrically programmable ROM (EPROM), an electrically erasable programmable ROM (EEPROM), or a flash memory. The volatile memory can include randomly accessible memory, which serves as external high speed cashing memory. As an example, but not limited to, the RAM can be obtained from various ways, such as synchronous RAM (SRAM), dynamic RAM (DRAM), synchronous DRAM (SDRAM), double data rate SDRAM (DDR SDRAM), enhanced SDRAM (ESDRAM), synchronous link DRAM (SLDRAM) and direct Rambus RAM (DRRAM). The storage devices according to aspects of the present application can include these memories and any memories of other suitable types, but not limited thereto.

Those skilled in the art should also appreciate that various exemplary logic blocks, modules, circuits and algorithmic steps incorporated in the present application can be implemented as electronic hardware, computer software or both. For clear explanation of such interchangeability between hardware and software, general descriptions have been given on functions of various exemplary components, blocks, module, circuits and steps. Whether such functions are implemented in software or hardware depends on particular implementation and design constraints imposed on the entire system. Those skilled in the art can implement such functions with respect to each particular application and in a variety of manners, but such implementation decision cannot be construed as out of the scope of the present application.

Various exemplary logic blocks, modules, circuits and algorithmic steps incorporated in the present application can be designed to be implemented or performed by a component(s) listed below for executing the functions described herein: a general processor, a digital signal processor (DSP), an application specific integrated circuit (ASIC), a field programmable gate array (FPGA) or other programmable logic device, split gate or transistor logic, separate hardware components, or any combination of these components. A general processor can be a microprocessor, but alternatively, can be any traditional processors, controllers, microcontrollers, or state machines. Processors can also be implemented as a combination of a computing device, for example, a combination of multiple microprocessors and DSP, multiple microprocessors, one or more microprocessor in combination with a DSP core, or any other such configuration.

Various exemplary steps of the method or algorithm incorporated in the present application can be directly incorporated in hardware, software module executed by the processor or the combination of the two. The software modules can reside in a RAM, a flash memory, a ROM, an EPROM, an EEPROM, a register, hard disk, removable disk, CD-ROM or storage medium in any other known form in the art. An exemplary storage medium is coupled into a processor, enabling the processor to read information from the storage medium or to write information into the storage medium. In an alternative mode, the storage medium can be incorporated with the processor. The processor and the storage medium may reside in an ASIC, which may reside in a user terminal. In an alternative mode, the processor and the storage medium may reside in the user terminal as separate components.

In one of more exemplary designs, these functions can be implemented in hardware, software, firmware or any combination of the above. If the functions are implemented in software, they can be stored in a computer readable medium or transmitted through a computer readable medium as one or more instructions or code. Said computer readable medium include computer storage medium or transmission medium which includes any medium that facilitates transmission of a computer program from one location to another. Said storage medium may be any usable medium that are accessible by a general purpose computer or dedicated computer. As an example, but not limited to, said computer readable medium can include RAM, ROM, EEPROM, CD-ROM or any other optic storage device, disk storage device or any other magnetic storage device, or may be any other medium for carrying or storing program code in the form of instructions or data structures and accessible by general purpose computers or dedicated computers or general purpose or special use processors. Also, any connections can be suitably called computer readable medium. For example, if software is transmitted from a website, a server or any other remote source via a coaxial cable, optic cable, twisted-pair cable, digital subscriber line (DSL) or wireless technology such as infrared, radio and microwave, then said coaxial cable, optic cable, twisted-pair cable, digital subscriber line (DSL) or wireless technology such as infrared, radio and microwave all fall in the definition of the medium. As used herein, magnetic disks and optic disks include compact discs (CD), laser discs, optic discs, digital versatile discs, floppy disks and blue-ray discs, wherein magnetic disks typically reproduce data magnetically while optic disks reproduce data optically using laser. The combination of the above should also fall in the scope of a computer readable medium.

Exemplary embodiments are given above, but it should be noted that these are merely disclosed exemplary embodiments. On the premise of not violating the scope of the present application defined in the claims, various change and modifications can be done. The functions, steps and/or actions defined in the method claims of the embodiments do not necessarily be performed in any particular order. Also, although elements of the present application may be described or claimed in a singular form, said elements can be seen as plural, unless specifically limited to being singular.

It should be noted, unless otherwise supported clearly in the context, a singular form “a” (“a”, “an”, “the”) is intended in included plural forms. It should be noted that the phrasing of “and/or” in this text refers to inclusion of any one of one or more items associated listed or a combination of all of the items.

The above reference numerals in the embodiments of the present application are merely for description purpose and do not indicate the advantages or disadvantages of the embodiments.

Those skilled in the art can appreciate that all or parts of the steps in the above embodiments can be completed via hardware or through programs instructing hardware. Such programs can be stored in a computer readable storage medium, which may be read-only storage, magnetic disks or optical disks, etc.

The above are merely particular embodying modes of the present application, but the protection scope of the present application is not limited thereto. Any one skilled in the art can readily conceive of changes or substitutions in the technical scope as disclosed in the present application, which changes or substitutions should all fall in the protection scope of the present application. Therefore, the protection range of the present application should be determined only by the accompanying claims.

1. A method for searching video contents, comprising:
at an electronic device:
obtaining a plot search keyword for a target video; and
obtaining, from pre-stored additional information of the target video, a first playback time information of a first video plot information matching the plot search keyword, wherein the additional information of the target video is for recording the video plots information of the target video and the playback time information corresponding to the video plots information.

2. The method of claim 1, wherein the obtaining, from pre-stored additional information of the target video, a first playback time information of a first video plot information matching the plot search keyword comprises:
obtaining, from pre-stored video plots information, the first video plot information matching the plot search keyword; and
obtaining, from the additional information of the target video, the first playback time information corresponding to the first video plot information.

3. The method of claim 1, wherein the obtaining, from pre-stored additional information of the target video, a first playback time information of a first video plot information matching the plot search keyword further comprises:
sending the plot search keyword to a server, and receiving the first playback time information from the server.

4. The method of claim 1, wherein the method further comprises:
obtaining a second video plot information of the target video and a second playback time information; and
storing the second video plot information and the second playback time information in association with the additional information of the target video.

5. The method of claim 4, wherein the storing the second video plot information and the second playback time information in association with the additional information of the target video comprises:
sending the second video plot information and the second playback time information to a server, and receiving from the server a message for notifying the second video plot information and the second playback time information being stored in association with the additional information of the target video.

6. An electronic device, comprising:
at least one processor; and
a memory communicably connected with the at least one processor for storing instructions executable by the at least one processor,
wherein execution of the instructions by the at least one processor causes the at least one processor to:
obtain a plot search keyword for a target video; and
obtain, from pre-stored additional information of the target video, a first playback time information of a first video plot information matching the plot search keyword, wherein the additional information of the target video is for recording the video plots information of the target video and the playback time information corresponding to the video plots information.

7. The electronic device of claim 6, wherein execution of the instructions by the at least one processor further causes the at least one processor to:
obtain, from pre-stored video plots information, the first video plot information matching the plot search keyword; and
obtain, from the additional information of the target video, the first playback time information corresponding to the first video plot information.

8. The electronic device of claim 6, wherein execution of the instructions by the at least one processor further causes the at least one processor to:
send the plot search keyword to a server, and receive the first playback time information from the server.

9. The electronic device of claim 6, wherein execution of the instructions by the at least one processor further causes the at least one processor to:
obtain a second video plot information of the target video and a second playback time information; and
store the second video plot information and the second playback time information in association with the additional information of the target video.

10. The electronic device of claim 9, wherein execution of the instructions by the at least one processor further causes the at least one processor to:
send the second video plot information and the second playback time information to a server, and receive from the server a message for notifying the second video plot information and the second playback time information being stored in association with the additional information of the target video.

11. (canceled)

12. (canceled)

13. (canceled)

14. A non-transitory computer-readable storage medium storing executable instructions that, when executed by an electronic device, cause the electronic device to:
obtain a plot search keyword for a target video; and
obtain, from pre-stored additional information of the target video, a first playback time information of a first video plot information matching the plot search keyword, wherein the additional information of the target video is for recording the video plots information of the target video and the playback time information corresponding to the video plots information.

15. The non-transitory computer-readable storage medium of claim 14, wherein execution of the instructions further causes the electronic device to:
obtain, from pre-stored video plots information, the first video plot information matching the plot search keyword; and
obtain, from the additional information of the target video, the first playback time information corresponding to the first video plot information.

16. The non-transitory computer-readable storage medium of claim 14, wherein execution of the instructions further causes the electronic device to:
send the plot search keyword to a server, and receive the first playback time information from the server.

17. The non-transitory computer-readable storage medium of claim 14, wherein execution of the instructions further causes the electronic device to:
obtain a second video plot information of the target video and a second playback time information; and
store the second video plot information and the second playback time information in association with the additional information of the target video.

18. The non-transitory computer-readable storage medium of claim 17, wherein execution of the instructions further causes the electronic device to:
send the second video plot information and the second playback time information to a server, and receive from the server a message for notifying the second video plot information and the second playback time information being stored in association with the additional information of the target video.
